(19) United States
(12) Patent Application Publication
(10) Pub. No.: US 2026/0079321 A1
(43) Pub. Date: Mar. 19, 2026

(54) OPTICAL APPARATUS AND IMAGING APPARATUS

(71) Applicant: CANON KABUSHIKI KAISHA, Tokyo (JP)

(72) Inventor: NOBUYUKI NAGAOKA, Tochigi (JP)

(21) Appl. No.: 19/318,854

(22) Filed: Sep. 4, 2025

(30) Foreign Application Priority Data
Sep. 17, 2024 (JP) 2024-159713

(51) Int. Cl. G02B 7/10; G02B 7/02; G02B 7/14

(52) U.S. Cl. CPC G02B 7/10; G02B 7/021; G02B 7/026; G02B 7/14

(57) ABSTRACT

Provided is an optical apparatus comprising: a first, a second and a third holding member each holding an optical element; a cover member; and a cam ring comprising a plurality of cam grooves; wherein each of the first to third holding members and the cover member includes a cam follower that engages with one of the plurality of the cam grooves; wherein the first to third holding members and the cover member are configured to move in an optical axis direction by rotation of the cam ring around an optical axis; and wherein the first and second holding members are biased against each other, and the third holding member and the cover member are biased against each other.

### BACKGROUND

### Field of the Technology

The present disclosure relates to an optical apparatus and an imaging apparatus including the same.

### Description of the Related Art

U.S. Pat. No. 9,128,239 discloses a configuration in which a lens holding frame that holds a lens is suspended by a cam follower that engages with a cam groove provided in a cam ring so that the lens holding frame can move forward and backward in the optical axis direction in accordance with the rotation of the cam ring.

### SUMMARY

According to an embodiment of the present disclosure, there is provided an optical apparatus comprising: a first, a second and a third holding member each holding an optical element; a cover member; and a cam ring comprising a plurality of cam grooves; wherein each of the first to third holding members and the cover member includes a cam follower that engages with one of the plurality of the cam grooves; wherein the first to third holding members and the cover member are configured to move in an optical axis direction by rotation of the cam ring around an optical axis; and wherein the first and second holding members are biased against each other, and the third holding member and the cover member are biased against each other.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view of a zoom lens (1) according to an embodiment of the present disclosure in a wide-angle state.

FIG. 2 is a cross-sectional view of the zoom lens (1) according to the embodiment of the present disclosure in a telephoto state.

FIG. 3A is a side view showing a state in which a zoom lens unit is incorporated in a cam ring (105) and a guide barrel (102).

FIG. 3B is a side view showing a state in which the zoom lens unit is incorporated in the cam ring (105) and the guide barrel (102).

FIG. 4A is a side view showing a state in which a zoom lens unit is incorporated in the guide barrel (102).

FIG. 4B is a side view showing a state in which a zoom lens unit is incorporated in the guide barrel (102).

FIG. 5 is a front view of only the zoom lens unit.

FIG. 6 is a side view of only the zoom lens unit.

FIG. 7 is a rear view of only the zoom lens unit.

FIG. 8 is a graph of each movement amount of the zoom lens unit.

FIG. 9 is a graph of a relative movement amount of the zoom lens unit.

FIG. 10 is a graph of each intersection angle of the zoom lens unit.

FIG. 11 is a graph of the intersection angle difference of the zoom lens unit.

FIG. 12 is a schematic diagram illustrating a configuration example of an imaging apparatus.

### DESCRIPTION OF THE EMBODIMENTS

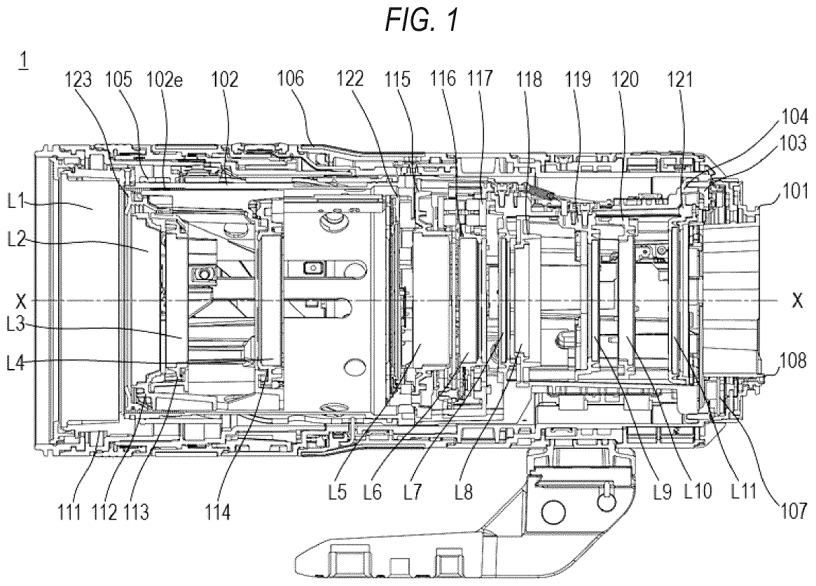

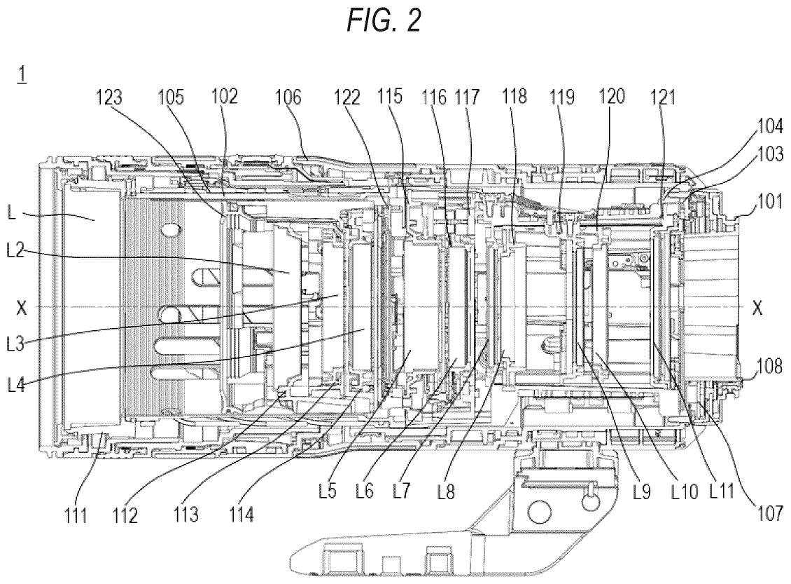

Preferred embodiments of the present disclosure will now be described in detail in accordance with the accompanying drawings. The X-X axis of the drawing represents the optical axis. FIG. 1 is a cross-sectional view of a zoom lens 1 (optical apparatus) according to an embodiment of the present disclosure along an optical axis in a wide-angle state. FIG. 2 is a cross-sectional view of the zoom lens 1 according to the embodiment of the present disclosure in a telephoto state. A wide-angle end is a zoom state on the widest angle side in the zoom lens 1, and a telephoto end is a zoom state on the most telephoto side.

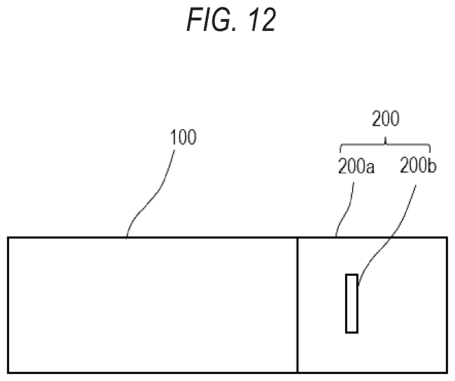

In FIG. 1, a mount 101 is a component fixed to a camera body 200a shown in FIG. 12. A guide barrel 102 is integrally fixed to the mount 101 together with a fixed barrel 103 via a rear unit base 104.

A cam ring 105 is rotatably held around the optical axis on an outer periphery of the guide barrel 102. The cam ring 105 is connected to a zoom ring 106 rotatably held on the outer periphery of the fixed barrel 103 by a zoom key (not shown) and is configured to be integrally rotated by operating the zoom ring 106 from the outside.

A zoom sensor (not shown) is attached to the fixed barrel 103. The zoom sensor is a sensor capable of electrically detecting a rotation angle of the zoom ring 106 and is electrically connected to a control board 107 arranged in the vicinity of the mount 101 to transmit focal length information during zooming to the control circuit.

A contact block 108 is electrically connected to the control board 107 and has a function of communicating with the camera body 200a shown in FIG. 12 and receiving supply of electric power.

A first unit lens L1 is held by a first unit barrel 111, and the first unit barrel 111 is fixed to the guide barrel 102. A second unit lens L2 (first lens unit) is held by a second unit barrel 112. A third unit lens L3 (second lens unit) is held by a third unit barrel 113. A fourth unit lens L4 (third lens unit) is held by a fourth unit barrel 114. A fifth unit lens L5 is held by a fifth unit barrel 115. The fifth unit barrel 115 is fixed to the rear unit base 104. An electromagnetic diaphragm unit 122 is held by the fifth unit barrel 115, and the electromagnetic diaphragm unit 122 is electrically connected to the control board 107.

A sixth unit lens L6 is held by a sixth unit barrel 116. The sixth unit barrel 116 is held by a shift unit 117 so as to be movable in a plane orthogonal to the optical axis. The shift unit 117 includes an actuator for driving the sixth unit barrel 116, a sensor for detecting a driving amount, and the like, and is fixed to the rear unit base 104. The shift unit 117 is electrically connected to the control board 107. The control board 107 drives and controls the sixth unit barrel 116 so as to correct a shake based on a shake signal detected by an acceleration sensor (not shown) attached to the fixed barrel 103. A seventh unit lens L7 is held by the rear unit base 104.

An eighth unit lens L8 is held by an eighth unit barrel 118 so as to be movable in the optical axis direction by a guide bar (not shown). The seventh unit lens L7 is a lens for focus adjustment and is driven in the optical axis direction by a linear vibration wave motor (not shown) held by the rear unit base 104. The linear vibration wave motor is driven in the optical axis direction by vibrating a piezoelectric element at a frequency in an ultrasonic range and is based on a well-known technique. The linear vibration wave motor is electrically connected to the control board 107 by a flexible board (not shown).

A ninth unit lens L9 is held by a ninth unit barrel 119. The ninth unit barrel 119 is fixed to the rear unit base 104.

A tenth unit lens L10 is held by a tenth unit barrel 120 so as to be movable in the optical axis direction by a guide bar (not shown). The tenth unit lens L10 is a lens for focus adjustment similarly to the eighth unit lens L8 and is driven in the optical axis direction by another linear vibration wave motor (not shown) held by the rear unit base 104. This linear vibration wave motor is also electrically connected to the control board 107 by a flexible substrate (not shown).

An eleventh unit lens L11 is held by an eleventh unit barrel 121. The eleventh unit barrel 121 is fixed to the rear unit base 104. A cover member 123 is arranged closer to the object side than the second unit barrel 112.

Each of the second unit lens L2, the third unit lens L3, and the fourth unit lens L4 is a lens that moves for zooming, and cam followers, which will be described later, are fixed to the second unit barrel 112, the third unit barrel 113, the fourth unit barrel 114, and the cover member 123. Each cam follower is engaged with a plurality of straight grooves provided in the guide barrel 102 and a plurality of cam grooves provided in the cam ring 105 and is configured to be able to move straight in the optical axis direction by rotating the cam ring 105. That is, the guide barrel 102 guides the plurality of lens barrels and the cover member 123 in the optical axis direction. The zoom lens 1 includes the second unit lens L2, the third unit lens L3, and the fourth unit lens L4 which respectively hold optical elements, the cover member 123, and the cam ring 105 having a plurality of cam grooves, and each of the second unit lens L2, the third unit lens L3, the fourth unit lens L4, and the cover member 123 has a cam follower which engages with the plurality of cam grooves.

Further, the eighth unit lens L8 and the tenth unit lens L10 for focus adjustment are driven in the optical axis direction by respective linear vibration wave motors in accordance with zooming. During zooming, at each focal length from the wide-angle side to the telephoto side, position information (in-focus position information) of the eighth unit lens L8 and the tenth unit lens L10 for focusing on each focus position from infinity to close range is stored. Based on the information and focal distance information detected by a zoom sensor (not shown), the eighth unit lens L8 and the tenth unit lens L10 are driven and controlled.

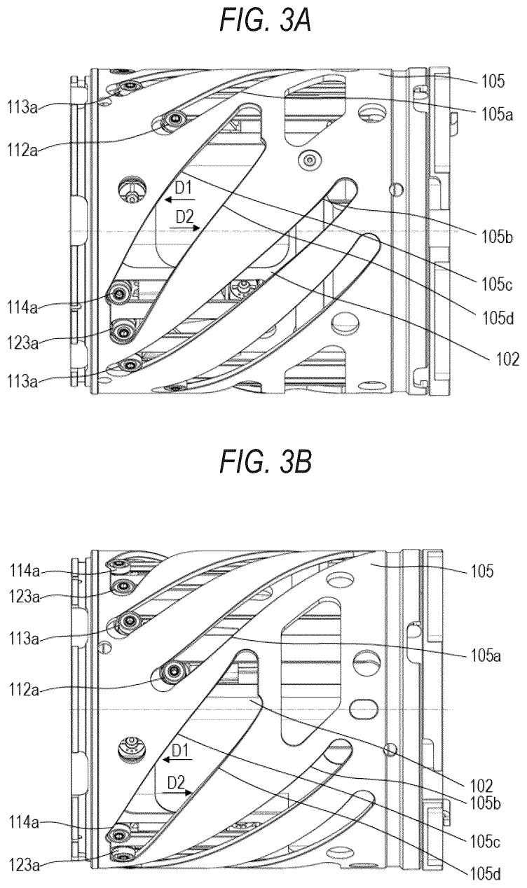

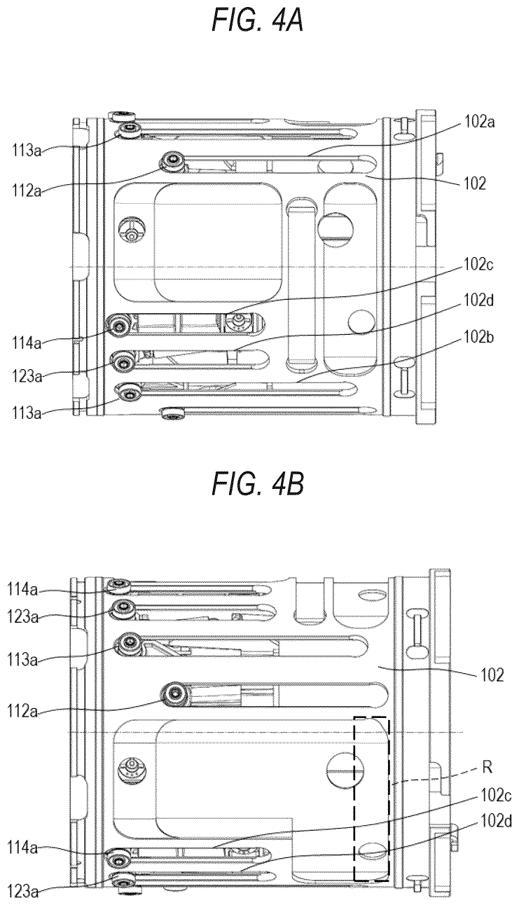

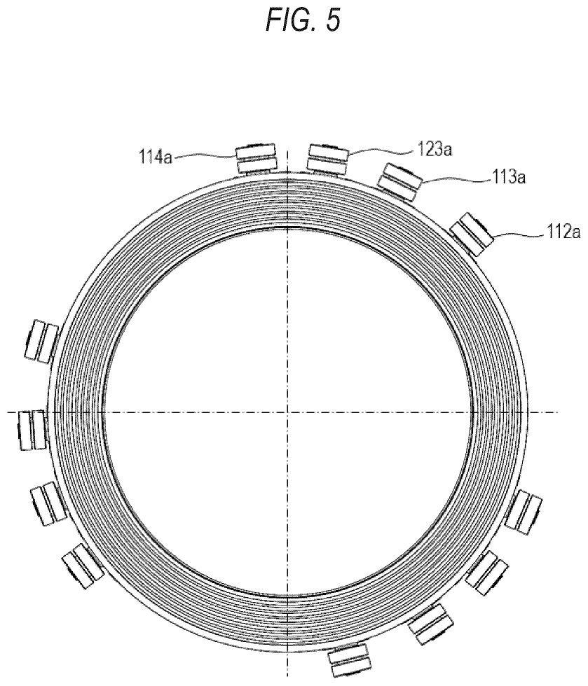

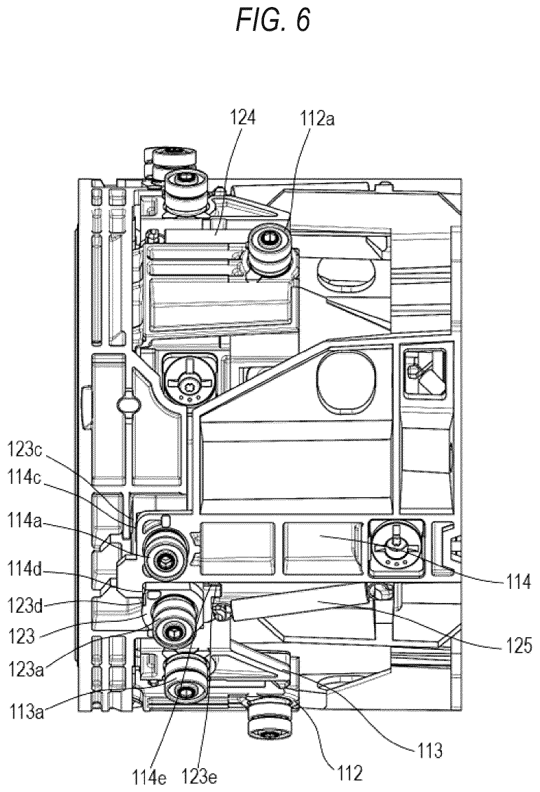

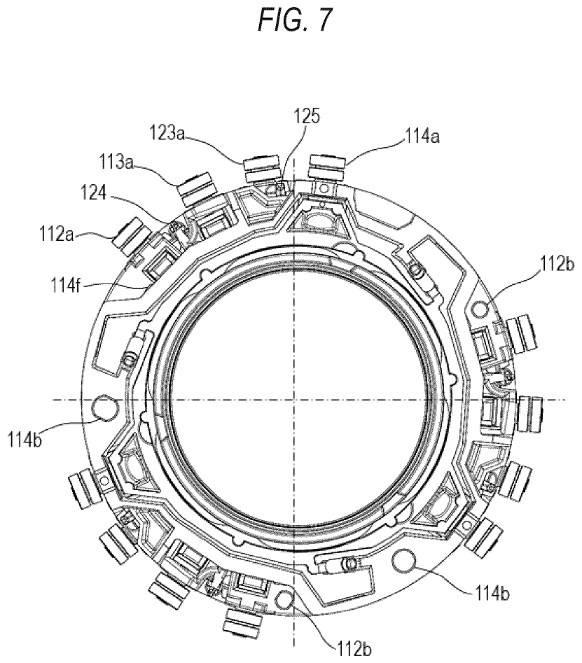

Next, the configuration of the zoom unit will be described in detail. FIG. 3A and FIG. 3B are side views showing a state in which the zoom lens unit is incorporated in the cam ring 105 and the guide barrel 102, and FIG. 3A and FIG. 3B show states viewed from different angles. FIG. 4A and FIG. 4B are side views showing a state in which the zoom lens unit is incorporated in the guide barrel 102, and FIG. 4A and FIG. 4B show states viewed from different angles. FIG. 5 is a front view of only the zoom lens unit. FIG. 6 is a side view of only the zoom lens unit. FIG. 7 is a rear view of only the zoom lens unit.

The second unit barrel 112 is provided with a second unit cam follower 112a (first cam follower), and the third unit barrel 113 is provided with a third unit cam follower 113a (second cam follower). The fourth unit barrel 114 is provided with a fourth unit cam follower 114a (third cam follower), and the cover member 123 is provided with a cover member cam follower 123a (fourth cam follower).

The cam ring 105 is provided with a second unit cam groove 105a (first cam groove), a third unit cam groove 105b (second cam groove), a fourth unit cam groove 105c (third cam groove) and a cover member cam groove 105d (fourth cam groove). The guide barrel 102 is provided with a second unit straight groove 102a, a third unit straight groove 102b, a fourth unit straight groove 102c, and a cover member straight groove 102d (third straight groove). The second unit cam follower 112a, the third unit cam follower 113a, the fourth unit cam follower 114a, and the cover member cam follower 123a are engaged with the second unit cam groove 105a, the third unit cam groove 105b, the fourth unit cam groove 105c, and the cover member cam groove 105d, respectively. And the second unit cam follower 112a, the third unit cam follower 113a, the fourth unit cam follower 114a, and the cover member cam follower 123a are engaged with the second unit straight groove 102a, the third unit straight groove 102b, the fourth unit straight groove 102c, and the cover member straight groove 102d, respectively. That is, the guide barrel 102 has a plurality of straight grooves for guiding the plurality of lens barrels and the cover member 123 in the optical axis direction and restricts the movement of the cam ring 105 in the optical axis direction. Each of the multiple cam grooves engages with a respective one of the multiple cam followers. The plurality of cam grooves include the second unit cam groove 105a with which the second unit cam follower 112a of the second unit barrel 112 is engaged, the third unit cam groove 105b with which the third unit cam follower 113a of the third unit barrel 113 is engaged, the fourth unit cam groove 105c with which the fourth unit cam follower 114a of the fourth unit barrel 114 is engaged, and the cover member cam groove 105d with which a cover member cam follower 123a of the cover member 123 is engaged.

The fourth unit cam groove 105c and the cover member cam groove 105d are cam grooves that integrate the cam shapes corresponding to the fourth unit cam follower 114a and the cover member cam follower 123a. And the object side functions as a contact surface for the fourth unit cam follower 114a, and an image plane side functions as a contact surface for the cover member cam follower 123a. That is, the fourth unit cam follower 114a provided on the fourth unit barrel 114 and the cover member cam follower 123a provided on the cover member 123 are arranged inside the fourth unit cam groove 105c and the cover member cam groove 105d, which are the same integrated cam grooves. And the fourth unit cam follower 114a contacts a cam groove surface in a first direction D1 (the cam groove surface of the fourth unit cam groove 105c), and the cover member cam follower 123a contacts the cam groove surface in a second direction D2 (the cam groove surface of the cover member cam groove 105d), which is the opposite direction to the first direction D1.

The second unit barrel 112 and the third unit barrel 113 are biased by an inter unit biasing member 124 (first biasing member) which is a tension coil spring in a direction in which they approach each other. The second unit cam follower 112a is biased to the image plane side and the third unit cam follower 113a is biased to the object side by the biasing of the inter unit biasing member 124 and abut on one surface of the cam groove and the straight groove.

The fourth unit barrel 114 and the cover member 123 are also biased by a fourth unit biasing member 125 (a second biasing member), which is a tension coil spring, in a direction approaching each other. By the biasing of the fourth unit biasing member 125, the cover member cam follower 123a is moved to the image plane side, and the fourth unit cam follower 114a is moved to the object side, so as to abut on one surface of the cam groove and the straight groove.

In this embodiment, the biasing member is constituted by the tension coil spring which is advantageous in that the arrangement space is saved but may be constituted by a compression coil spring. All of the cam followers employ bearings and reduce the zoom torque by rolling with respect to the cam grooves and the straight grooves. In addition, the backlash between the cam follower, the cam groove, and the straight groove is suppressed, so that the focus movement due to the hysteresis at the time of zoom reversal and the deterioration of the optical performance are suppressed.

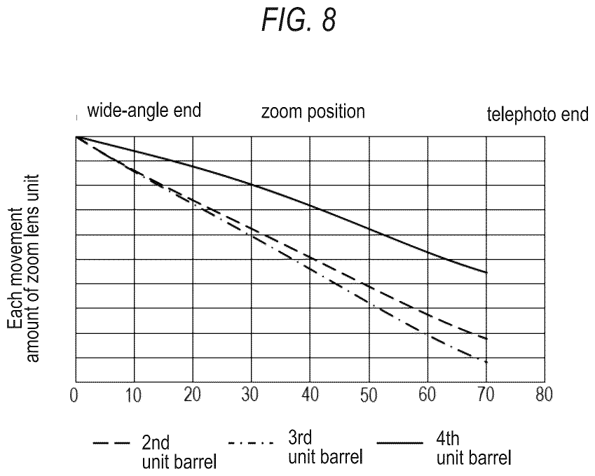

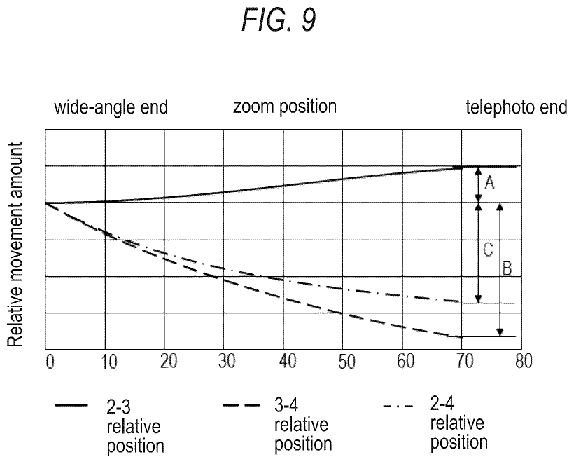

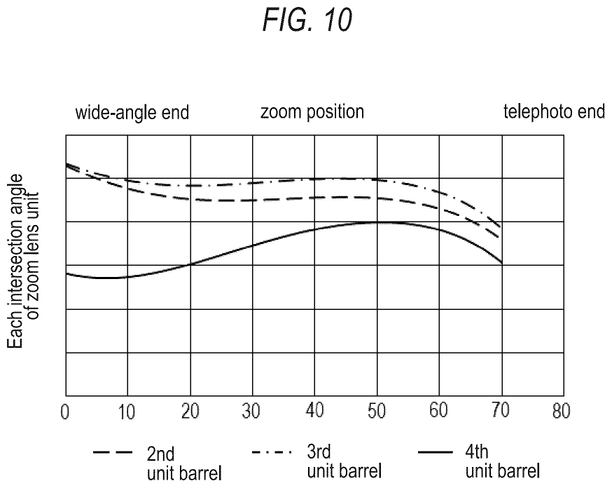

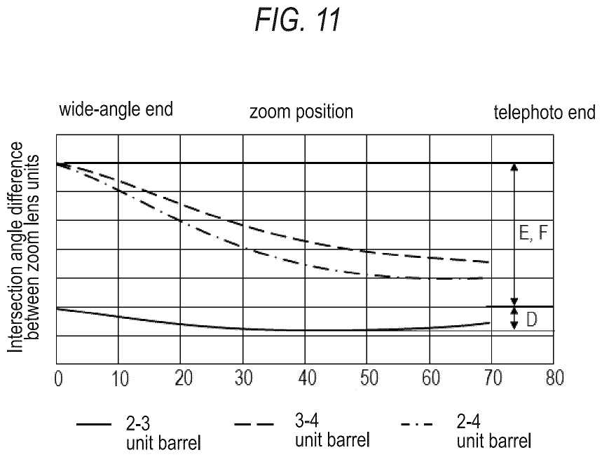

Next, the relationship between the trajectory of each zoom lens unit and the rotational torque of the cam ring 105 due to biasing will be described. FIG. 8 is a graph of each movement amount of the zoom lens unit, FIG. 9 is a graph of a relative movement amount of the zoom lens unit, FIG. 10 is a graph of each intersection angle of the zoom lens unit, and FIG. 11 is a graph of an intersection angle difference of the zoom lens unit.

As described above, the second unit barrel 112 (first holding member) as the first lens barrel, the third unit barrel 113 (second holding member) as the second lens barrel, the fourth unit barrel 114 (third holding member) as the third lens barrel, and the cover member 123 that does not hold a lens unit are configured to be movable in the optical axis direction when the cam ring 105 rotates around the optical axis.

In the configuration disclosed in the related art, the backlash of the cam follower is suppressed with a minimum component configuration without adding a component by biasing all of the lens barrels. On the other hand, when the lens barrels are biased against each other, self-running torque, which is torque for rotating the cam ring, is generated unless the movement amount during zooming or the intersection angles of the cam grooves are approximate to each other.

The intersection angle is an angle formed by the cam groove provided in the cam ring and an axis in a direction orthogonal to the X-X axis which is the optical axis. The self-running torque increases as the relative movement amount between the moving units to be biased increases or as the difference in the intersection angle between the cam grooves of the moving units increases. Further, as the biasing force increases, the self-running torque also increases.

As an extension of the configuration disclosed in the related art, in order to suppress the self-running torque, it is necessary to prevent the cam ring from self-running by increasing the viscosity of the grease or the frictional force due to the biasing of the operation portion such as the zoom ring, which results in an increase in the zoom torque.

Therefore, in the three lens barrels that move in the optical axis direction during zooming, when the cam ring 105 is rotated from the wide-angle end to the telephoto end, a maximum relative movement amount between the second unit barrel 112 and the third unit barrel 113 based on the wide-angle end is A [mm]. Also, when the maximum relative movement amount between the third unit barrel 113 and the fourth unit barrel 114 based on the wide-angle end is B [mm], and the maximum relative movement amount between the second unit barrel 112 and the fourth unit barrel 114 based on the wide-angle end is C [mm], the inequalities A<B and A<C are preferably satisfied. A configuration in which a force is applied between the second unit barrel 112 and the third unit barrel 113, and between the fourth unit barrel 114 and the cover member 123, suppresses the self-running torque. Therefore, an optical apparatus capable of suppressing an increase in zoom torque can be provided.

Similarly, in terms of the intersection angle, when the cam ring 105 is rotated from the wide-angle end to the telephoto end, the maximum value of the difference in the intersection angle between the second unit cam groove 105a and the third unit cam groove 105b among the plurality of cam grooves is denoted by D [deg]. Further, when the maximum value of the difference between the intersection angles of the third unit cam groove 105b and the fourth unit cam groove 105c is E [deg] and the maximum value of the difference between the intersection angles of the second unit cam groove 105a and the fourth unit cam groove 105c is F [deg], the inequalities D<E and D<F are preferably satisfied. Then, it is biased between the second unit barrel 112 moving along the second unit cam groove 105a and the third unit barrel 113 moving along the third unit cam groove 105b. In addition, a configuration in which self-running torque is suppressed is realized by a configuration in which biasing is performed between the fourth unit barrel 114 that moves along the fourth unit cam groove 105c and the cover member 123. Therefore, it is possible to provide an optical apparatus capable of suppressing an increase in zoom torque.

From either viewpoint, biasing between the second unit barrel 112 and the third unit barrel 113 is a configuration capable of suppressing the self-running torque most. Further, the fourth unit cam groove 105c is provided with surfaces with which the cover member cam follower 123a and the fourth unit cam follower 114a are brought into contact, respectively, and the cam shapes are the same, so that the self-running torque due to the biasing is not generated.

In this embodiment, the cover member 123 and the fourth unit barrel 114 are configured to be biased by the same cam, but in some cases, the influence of the second third unit self-running torque (first torque) for rotating the cam ring 105, which is generated when the second unit barrel 112 and the third unit barrel 113 are biased against each other, cannot be ignored. In such cases, the cam trajectory corresponding to the cover member cam follower 123a of the cover member 123 is changed. Then, it is possible to configure the cover member 123 to cancel the second- and third-unit self-running torque with the self-running torque (second torque) that rotates the cam ring 105, which occurs when biasing between the cover member 123 and the fourth unit barrel 114. Specifically, the direction is set to cancel the self-running torque against the second- and third-unit self-running torque. By adopting the above configuration, it is possible to achieve further suppression of the zoom torque.

As shown in FIG. 1, a cover member 123, the second unit barrel 112, the third unit barrel 113, and the fourth unit barrel 114 are arranged in this order from the object side. The second unit barrel 112 and the third unit barrel 113 are adjacent to each other in the optical axis direction and are biased against each other by the inter unit biasing member 124, and the cover member 123 and the fourth unit barrel 114 are biased so as to sandwich the two units. Further, the third unit barrel 113 and the fourth unit barrel 114 are adjacent to each other in the optical axis direction. The cover member 123 is arranged closest to the object side in the optical axis direction and is adjacent to the second unit barrel 112.

The cover member 123 is arranged not between the third unit barrel 113 and the fourth unit barrel 114, but on the front side of the second unit barrel 112. The positions of the respective cam follower are such that the second unit cam follower 112a is on the image plane side with respect to the lens holding portion of the second unit lens L2, and the fourth unit cam follower 114a is on the object side with respect to a lens holding portion of the fourth unit lens L4. This makes it possible to reduce the clearance between the third unit barrel 113 and the fourth unit barrel 114 in the telephoto state, achieving a compact size of the entire lens barrel.

Further, as shown in FIG. 1, which is a cross-sectional view showing a cross section orthogonal to the optical axis, since the fourth unit barrel 114 is arranged so as to overlap the second unit barrel 112 and the third unit barrel 113, the clearance between the barrels is reduced in the optical axis direction, and miniaturization is realized. Alternatively, in the cross section orthogonal to the optical axis, two or more lens barrels of the second unit barrel 112 to the fourth unit barrel 114 may overlap each other.

As shown in FIG. 8, the movement amount of the cover member 123 in the optical axis direction by the rotation of the cam ring 105 during zooming is smaller than the movement amount of the second unit barrel 112 in the optical axis direction by the rotation of the cam ring 105 during zooming. That is, the cover member 123 arranged closest to the object side is always arranged closest to the object side in the zoom lens unit. Further, when the cam ring 105 is rotated from the wide-angle end to the telephoto end, the movement amount of the fourth unit barrel 114 in the optical axis direction is the same as the movement amount of the cover member 123 in the optical axis direction, and the fourth unit barrel 114 and the cover member 123 have the same movement trajectory. That is, during zooming, the fourth unit barrel 114 and the cover member 123 can be moved such that the interval therebetween in the direction along the optical axis does not change.

As shown in FIG. 1, the cover member 123 is provided with a light-shielding portion that functions as a light-shielding shape, and the light-shielding portion limits the range of light rays that strike a light-shielding line 102e provided on the inside diameter of the guide barrel 102. The light-shielding line 102e is provided to suppress a ghost in which light incident from the first unit lens L1 is reflected and forms an image on an imaging surface (not illustrated). The wider the range illuminated by the light-shielding line 102e, the greater the range in which the ghosts occur, and the greater their intensity. However, in this embodiment, the light-shielding portion of the cover member 123 having a small movement amount during zooming can limit the range of the light beam that hits the light-shielding line 102e, and therefore, there is an effect of suppressing the ghost.

As shown in FIG. 6, when viewed from the optical axis direction, the inter unit biasing member 124 is arranged between the second unit cam follower 112a provided on the second unit barrel 112 and the third unit cam follower 113a provided on the third unit barrel 113. This arrangement is intended to prevent, for example, when the biasing member is arranged at a phase away from the cam follower, a moment corresponding to the distance between the cam follower and the biasing member from being generated in the lens barrel to deform the lens barrel.

Similarly, when viewed from the optical axis direction, the fourth unit biasing member 125 is arranged between the fourth unit cam follower 114a provided on the fourth unit barrel 114 and the cover member cam follower 123a provided on the cover member 123. This arrangement is configured to prevent deformation of the fourth unit barrel 114 and the cover member 123, for example.

As described above, the respective optical axis positions of the cover member 123 and the fourth unit barrel 114 are determined by the respective cam followers coming into contact with the fourth unit cam groove 105c. However, in a case where an impact equal to or greater than the biasing force of the fourth unit biasing member 125 is applied, the cover member 123 and the fourth unit barrel 114 move between the fourth unit cam groove 105c.

In particular, in the intermediate zoom portion, each lens unit has a degree of freedom in the optical axis direction and the rotational direction, and hence a shock receiver is required. Therefore, the fourth unit barrel 114 is provided with a fourth unit front impact receiving 114c (contact surface) and a fourth unit rear impact receiving 114d (contact surface) on the front and rear sides in the optical axis direction. Further, the cover member 123 is provided with a cover member front impact receiving 123c (contact surface), a cover member rear impact receiving 123d (contact surface), and a cover member circumferential impact receiving 123c, which are impact receivers with the fourth unit barrel 114, at the front and rear in the optical axis direction.

When an impact is applied in the optical axis direction, the fourth unit front impact receiving 114c and the cover member front impact receiving 123c, or the fourth unit rear impact receiving 114d and the cover member rear impact receiving 123d come into contact with each other, thereby making it possible to prevent unintended damage to components. That is, between the fourth unit barrel 114 and the cover member 123, abutting surfaces which abut only at a time of impact are provided at the front and rear in the optical axis direction, respectively. For the impact in the direction orthogonal to the optical axis, a fourth unit circumferential impact receiving 114e and the cover member circumferential impact receiving 123e come into contact with each other, thereby preventing unintended damage to the components.

As shown in FIG. 7, when viewed from the image plane side, the fourth unit barrel 114 is provided with a fourth unit concave portion 114f, and the second unit barrel 112 and the third unit barrel 113 are exposed through the fourth unit concave portion 114f and are configured to be positioned by jigs at the time of assembly. Further, the fourth unit barrel 114 is provided with a fourth unit positioning hole 114b, and the second unit barrel 112 is provided with a second unit positioning hole 112b. By providing the jigs with pins, the lens barrels can be positioned with a simple configuration.

As described above, since the movement amount of the fourth unit barrel 114 is small, the lengths of the fourth unit straight groove 102c and the cover member straight groove 102d are also arranged to be short as shown in 4B of the drawing. The fourth unit straight groove 102c with which the fourth unit cam follower 114a of the fourth unit barrel 114 arranged in the guide barrel 102 comes into contact is arranged on the object side. The zoom key (not shown) is provided in a range where the fourth unit straight groove 102c and the cover member straight groove 102d are not provided at the optical axis position and is provided between the second unit straight groove 102a and the third unit straight groove 102b when viewed from the optical axis direction. That is, a movement range R of the zoom key which rotationally connects the operation portion and the cam ring 105 is located in a range where the fourth unit straight groove 102c is not provided.

With the above-described configuration, the movement range R of the zoom key and the arrangement range of the straight grooves of a part of the zoom lens units can be overlapped with each other, so that the miniaturization of the optical apparatus is realized. Although the biasing method in the configuration in which the number of moving units is three and the number of cover member 123 is one has been described so far, the zoom torque can be reduced by applying the above-described concept even in a case where the number of moving units is four.

When the fifth unit barrel 115, which is the fourth lens barrel, also serves as a zoom lens unit in addition to the second unit barrel 112, the third unit barrel 113, and the fourth unit barrel 114, which are the zoom lens units described above, the relative movement amounts between the moving units or the respective unit intersection angle differences may be calculated, and a combination with the smallest difference may be selected. That is, when the cam ring 105 is rotated from the wide-angle end to the telephoto end, the first to fourth lens barrels may be biased by a combination of two lens barrels having the smallest maximum value of the relative movement amount based on the wide-angle end. Alternatively, a combination may be used in which the self-running torque of the first combination and the self-running torque of the second combination are cancelled out in the case of biasing between the moving units. That is, when the cam ring 105 is rotated from the wide-angle end to the telephoto end, based on the wide-angle end, assuming the angle between the cam groove and an axis in a direction orthogonal to the X-X axis which is the optical axis as the intersection angle, each lens barrel may be biased by a combination of two lens barrels which move along two cam grooves having the smallest difference in each intersection angle among the plurality of cam grooves. Alternatively, each holding member may be biased by a combination of two holding members that move along two cam grooves having the smallest maximum value of the difference.

Although preferred embodiments of the present disclosure have been described above, the present disclosure is not limited to these embodiments, and various modifications and changes can be made within the scope of the gist of the present disclosure. According to the present exemplary embodiment, in a case where the movable units that move for zooming are biased, the self-running torque can be suppressed by biasing the movable units in a combination in which the relative movement amount between the zoom lens units or the intersection angle difference between the zoom lens units is small. Therefore, it is possible to provide an optical apparatus capable of suppressing an increase in the zoom torque.

As described above, the optical apparatus according to the embodiment of the present disclosure can suppress the self-running torque and suppress an increase in the zoom torque even when the movable units are biased against each other. In the above-described embodiments, the interchangeable lens has been described, but the present disclosure can also be applied to an image pickup apparatus integrally provided in a camera body, a digital still camera, a video camera, and the like.

FIG. 12 is a schematic diagram illustrating a configuration example of a camera apparatus 200 (imaging apparatus) using an optical apparatus to which the present disclosure is applied. The imaging apparatus includes a lens unit 100 and the camera apparatus 200 including the camera body 200a having an image sensor 200b for capturing an image of an object formed by the lens unit 100. Further, the imaging apparatus may have a configuration in which the lens unit 100 is detachably attached to the camera body 200a of the camera apparatus 200.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-159713, filed Sep. 17, 2024, which is hereby incorporated by reference herein in its entirety.

What is claimed is:

1. An optical apparatus comprising:
a first, a second and a third holding member each holding an optical element;
a cover member; and
a cam ring comprising a plurality of cam grooves;
wherein each of the first to third holding members and the cover member includes a cam follower that engages with one of the plurality of the cam grooves;
wherein the first to third holding members and the cover member are configured to move in an optical axis direction by rotation of the cam ring around an optical axis; and
wherein the first and second holding members are biased against each other, and the third holding member and the cover member are biased against each other.

2. The optical apparatus according to claim 1, further comprising a guide barrel configured to guide each of the first to third holding members and the cover member in the optical axis direction and to restrict movement of the cam ring in the optical axis direction.

3. The optical apparatus according to claim 1,
wherein the following inequalities are satisfied:
when the cam ring is rotated from a wide-angle end to a telephoto end, a maximum value of a relative movement amount between the first and second holding members is A [mm], the maximum value of the relative movement amount between the second and third holding members is B [mm], and the maximum value of the relative movement amount between the first and third holding members is C [mm]:
$$A < B and A < C .$$

4. The optical apparatus according to claim 1,
wherein the following inequalities are satisfied:
wherein the plurality of the cam grooves include a first cam groove with which the cam follower of the first holding member engages, a second cam groove with which the cam follower of the second holding member engages, a third cam groove with which the cam follower of the third holding member engages, and a fourth cam groove with which the cam follower of the cover member engages;
when the cam ring is rotated from a wide-angle end to a telephoto end, a maximum value of a difference between an angle formed by an axis perpendicular to the optical axis and the first cam groove and the angle formed by the axis and the second cam groove is D [deg], the maximum value of the difference between the angle formed by the axis and the second cam groove and the angle formed by the axis and the third cam groove is E [deg], and the maximum value of the difference between the angle formed by the axis and the first cam groove and the angle formed by the axis and the third cam groove is F [deg]:
$$D < E and D < F .$$

5. The optical apparatus according to claim 4,
when the cam ring is rotated from the wide-angle end to the telephoto end, each of the holding members is biased by a combination of two holding members among the plurality of holding members in which the maximum value of relative movement amount is smallest, or a combination of two holding members that move along the two cam grooves in which the maximum value of the difference is smallest.

6. The optical apparatus according to claim 1,
wherein the first holding member and the second holding member are adjacent to each other in the optical axis direction, the second holding member and the third holding member are adjacent to each other in the optical axis direction, and the cover member is arranged closest to an object side in the optical axis direction and is adjacent to the first holding member.

7. The optical apparatus according to claim 1,
wherein a movement amount of the cover member in the optical axis direction by a rotation of the cam ring is smaller than a movement amount of the first holding member in the optical axis direction by the rotation of the cam ring.

8. The optical apparatus according to claim 1,
wherein a third cam follower provided on the third holding member and a fourth cam follower provided on the cover member are arranged inside a same cam groove, the third cam follower abuts on a cam groove surface in a first direction, and the fourth cam follower abuts on a cam groove surface in a second direction opposite to the first direction.

9. The optical apparatus according to claim 1,
wherein contact surfaces which are brought into contact with each other only at a time of an impact are provided between the third holding member and the cover member on front and rear sides in the optical axis direction, respectively.

10. The optical apparatus according to claim 1,
wherein a first cam follower of the first holding member is arranged closer to an image plane side than a lens holding portion of the first holding member; the third cam follower of the third holding member is arranged closer to an object side than the lens holding portion of the third holding member, and the first holding member and the third holding member overlap each other in a cross section orthogonal to the optical axis.

11. The optical apparatus according to claim 2,
wherein a third straight groove, which abuts against a third cam follower of the third holding member arranged on the guide barrel, is arranged on an object side, and a movement range of a zoom key that rotatably connects an operation portion and the cam ring is located in a range where the third straight groove is not provided.

12. The optical apparatus according to claim 1,
wherein a first biasing member that biases the first holding member and the second holding member is arranged between a first cam follower provided on the first holding member and a second cam follower provided on the second holding member when viewed from the optical axis direction.

13. The optical apparatus according to claim 1,
wherein a second biasing member that biases the third holding member and the cover member is arranged between a third cam follower provided on the third holding member and a fourth cam follower provided on the cover member when viewed from the optical axis direction.

14. The optical apparatus according to claim 1,
wherein two or more of the first to third holding members overlap each other in a cross section orthogonal to the optical axis.

15. The optical apparatus according to claim 1,
wherein a first torque for rotating the cam ring, the first torque being generated when the first holding member and the second holding member are biased, and a second torque for rotating the cam ring, the second torque being generated when the third holding member and the cover member are biased, are oriented in a direction such that the second torque cancels out the first torque.

16. The optical apparatus according to claim 1,
wherein when the cam ring is rotated from a wide-angle end to a telephoto end, movement trajectories of the third holding member and the cover member are the same.

17. The optical apparatus according to claim 1,
wherein the optical apparatus is attachable to and detachable from an imaging apparatus.

18. An imaging apparatus comprising:
the optical apparatus according to claim 1;
and an imaging element that captures an image formed by the optical apparatus.
